(19) United States
(12) Patent Application Publication
(10) Pub. No.: US 2019/0028407 A1
(43) Pub. Date: Jan. 24, 2019

(54) QUALITY OF SERVICE COMPLIANCE OF WORKLOADS

(71) Applicant: HEWLETT PACKARD ENTERPRISE DEVELOPMENT LP, Houston, TX (US)

(72) Inventors: Gunalan Perumal Vijayan, Bangalore (IN); Saikat Mukherjee, Bangalore (IN); Satish Kumar Mopur, Bangalore (IN); Sridhar Balachandriah, Bangalore (IN)

(21) Appl. No.: 15/654,846

(22) Filed: Jul. 20, 2017

(51) Int. Cl. H04L 12/911; H04L 12/24; H04L 12/26; H04L 29/08

(52) U.S. Cl. CPC H04L 47/822; H04L 41/147; H04L 67/322; H04L 67/1097; H04L 43/08

(57) ABSTRACT

Example implementations relate to managing compliance of workloads to quality of service (QoS) parameters. An example includes collection of time-series network performance data from server systems and fabric interconnects related to traffic generated by workloads of the server systems. Rapid trends and long term trends for the workloads are calculated, using the collected network performance data as the input. Compliance of a high priority workload to an associated QoS parameter with the high priority workload is managed based on monitoring a rapid analytic trend for the high priority workload. Compliance of all of the workloads to respective QoS parameters is managed based on monitoring of long term analytic trends for the workloads.

### BACKGROUND

Electronic systems, such as servers and storage systems, may be connected to a network. Workloads of the electronic systems may generate traffic on the network. Changes in the workloads may result in changes to the traffic.

### BRIEF DESCRIPTION OF THE DRAWINGS

Various examples will be described below with reference to the following figures.

FIG. 1 is a block diagram depicting an example system that manages quality of service (QoS) compliance of workloads.

FIG. 2 is a block diagram depicting another example system that manages QoS compliance of workloads.

FIG. 3 is a flow diagram depicting an example method for managing QoS compliance of workloads.

FIG. 4 is a flow diagram depicting another example method for managing QoS compliance of workloads.

FIG. 5 is a block diagram of an example system that includes a non-transitory, machine readable medium encoded with example instructions to manage QoS compliance of workloads.

### DETAILED DESCRIPTION

In some examples, hyper convergence relates to tightly integrating storage, compute, and networking into a software defined infrastructure. Multiple compute servers and storage nodes (also referred to as hyper converged server nodes) may be deployed on and connected by a common network fabric (e.g., Ethernet). A hyper converged system may generate different types of workloads, and as a result, the common network fabric may carry many types of traffic. Moreover, the types of traffic carried over the fabric may dynamically change over time. Traffic types may include storage traffic that may exhibit bursty loads (e.g., in the case of a storage database), east-west network traffic that may include continuous I/O operations between nodes, virtual machine (VM) or container workload mobility traffic which may generate high workloads sustained over time, or other types of traffic.

Users of hyper converged systems may desire predictable I/O performance to be met for certain workloads (e.g., key applications or high priority workloads such as latency sensitive storage I/O and VM migration) while providing balanced resource utilization for many or all workloads and without starving lower priority workloads, and particularly where workloads are dynamically changing in a common fabric.

Some infrastructure may provide for manual priority specification and tuning of scheduling proportions with traffic shaping in fabric switches. However, this approach involves manual specification and, in dynamic workload performance situations, involves regular manual monitoring and tuning that is expensive and error prone. Also, some fabric switches may auto distribute spare bandwidth but are not driven by workload analytics and do not react to dynamic traffic requirements in a timely manner.

Accordingly, it may be useful to implement a dynamic QoS management system that is analytics and workload driven, as described in various examples herein below. Some examples described below provide orchestrated component-level fabric control that dynamically allocate and schedules network resources based on workload analytics and application requirements in a hyper converged environment.

Examples disclosed herein may include, among other things, a performance data analytics engine comprising a long term analytics module and a rapid analytics module to analyze workload patterns and resource consumption, an upper level controller for overall performance management (e.g., including managing QoS for low priority workloads) based on output of the long term analytics module, and a low level controller for quickly mitigating congestion situations (e.g., particularly for a high priority workload) based on output of the rapid analytics module. Some examples may also include an end-to-end orchestrator that mediates conflict between the upper level controller and the low level controller by rate throttling in certain fabric congestion scenarios.

By virtue of implementing analytics-driven dynamic QoS management as described herein, hyper converged infrastructure, or any networked infrastructure generally, may adapt to workload patterns and dynamics such as bursts, steep rises, and hotspots. Analytics-driven dynamic QoS management may be implemented in a distributed manner to provide dynamic control of resources at a component level (e.g., at a switch, at storage, a compute server node, or at a virtual storage appliance) for quick performance issue mitigation.

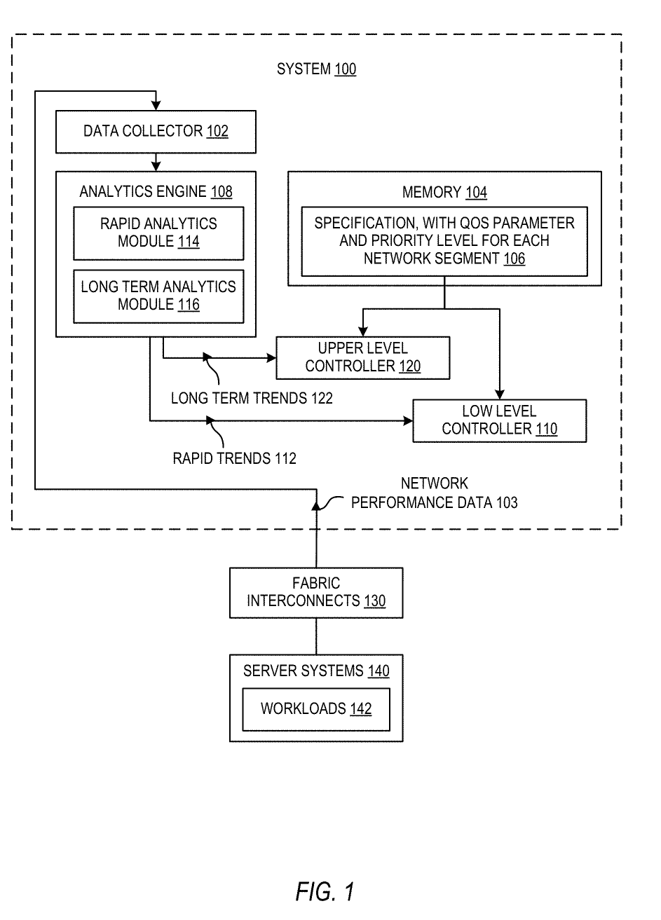

Referring now to the figures, FIG. 1 is a block diagram depicting an example system 100 that manages quality of service (QoS) compliance of workloads. The system 100 includes a data collector 102, a memory 104 (e.g., RAM, non-volatile RAM, etc.), an analytics engine 108 comprising a rapid analytics module 114 and a long term analytics module 116, a low level controller 110, and an upper level controller 120. The system 100 is connected to and in communication with fabric interconnects 130 (e.g., Ethernet fabric interconnects, such as switches). Server systems 140 are also connected to the fabric interconnects 130. For example, the server systems 140 may include a plurality of hyper converged system nodes (i.e., hypervisors hosting virtual machines and virtual storage appliances). In some implementations, server systems 140 may also include bare metal resources, a virtualized resource (e.g., a virtual machine), or a containerized resource. The server systems 140 may generate workloads 142, and the workloads 142 may generate associated network traffic that passes through server systems 140 and/or the fabric interconnects 130.

Traffic may be identified, segregated, and prioritized by workload. For example, in some implementations, traffic may be segregated in the fabric by VLAN (virtual LAN) tagging. Also, hypervisor nodes of the server systems 140 may identify and separate traffic by creating port groups tagged with VLAN IDs and assigning virtual machines generating workloads to respective port groups. Thus, the traffic may be tagged with VLAN ID identifying the workload and a workload priority. Additionally or alternatively, other techniques for segregating the traffic also may be implemented.

The data collector 102, the analytics engine 108 (including the rapid analytics module 114 and the long term analytics module 116), the low level controller 110, and the upper level controller 120 each may be any combination of hardware and programming to implement the functionalities described herein. In some implementations, the programming may be processor executable instructions stored on a non-transitory machine-readable storage medium, and the hardware may include at least one processing resource to retrieve and/or execute those instructions. Example processing resources include a microcontroller, a microprocessor, central processing unit core(s), an application-specific integrated circuit (ASIC), a field programmable gate array (FPGA), etc. Example non-transitory machine readable medium include random access memory (RAM), read-only memory (ROM), electrically erasable programmable read-only memory (EEPROM), flash memory, a hard disk drive, etc. The term “non-transitory” does not encompass transitory propagating signals. Additionally or alternatively, the data collector 102, the analytics engine 108 (including the rapid analytics module 114 and the long term analytics module 116), the low level controller 110, or the upper level controller 120 may include electronic circuitry or logic for implementing functionality described herein. In some examples, a combination of hardware and programming may be used to implement some aspects of the system 100 as a virtual machine, a container, or the like, deployed on hyper converged system.

The data collector 102 receives, from the server systems 140 and the fabric interconnects 130, time-series network performance data 103 related to traffic generated by workloads 142 of the server systems 140. For example, the data collector 102 may receive the data 103 in response to issuance by the data collector 102 of a status check command, health check command, data collection command, or the like, to a switch of fabric interconnects 130 or to a hypervisor of a server system 140. The workloads 142 may be generated by virtual machines deployed on the server systems 140, for example. Workload traffic may relate to, for example, storage traffic, VM cloning or migration, or east-west network traffic. Network performance data 103 may include one or more types of data from various sources. In some implementations, the network performance data 103 may include queue statistics from fabric interconnects 130, such as forwarding speed (in packets/second or bytes/second), current queue length (in packets or bytes), or packet drops (in packets/second or bytes/second). Additionally or alternatively, the network performance data 103 may include port statistics from server systems 140, such as total packets forwarded or total packet drops.

The memory 104 stores a specification 106 that describes, for each of the workloads 142, a quality of service (QoS) parameter and a priority level. The specification 106 may be generated and updated via a user interface or a template. In some implementations, the specification 106 may be generated via an application programming interface. The QoS parameter may specify, for example, a minimum bandwidth requirement per traffic type depending on its priority, or a level of tolerable network packet drop for any traffic type. The specification and QoS parameter may relate to a service level objective (SLO).

Using the network performance data 103 received by the data collector 102 as input, the rapid analytics module 114 calculates rapid trends for the workloads 142 and the long term analytics module 116 calculates long term trends for the workloads 142. In other words, the analytics engine 108 may calculate, for each workload, a rapid trend and/or a long term trend for a particular type of network performance data 103 (or combination of types), even if the network performance data 103 is collected from disparate sources.

The rapid trends and long term trends may include values or models based on statistical analysis, pattern detection, predictive modeling, etc. The rapid trends and long term trends differ in that rapid trends are based on sampling rates that are faster than the sampling rates on which the long term trends are based.

For example, the rapid analytics module 114 may calculate rapid trends using network performance data 103 received by the data collector 102 at a sampling rate on the order of a second or faster (e.g., on the order of microseconds). The rapid trends may include a moving average of the network performance data 103 (e.g., moving average of a queue length or of packet drops) or a linear regression of the network performance data 103, for example.

The long term analytics module 116 may calculate long term trends using network performance data 103 received by the data collector 102 at a sampling rate on the order of multiple seconds or slower (e.g., on the order of minutes). The long term analytics module 116 may perform noise reduction (e.g., using a moving average of the network performance data 103), trend pattern detection and prediction (e.g., using linear regression of the network performance data 103), rise/fall pattern detection (e.g., using slope analysis of the linear regression of the network performance data 103), or hot spot/cold spot detection (e.g., based on an area under a curve of network performance data 103 relative to the linear regression). Example implementations for calculating some of the foregoing long term trends will now be described.

Rise/fall pattern detection may entail a slope classification that may include calculating the slope of a type of network performance data 103 over a segment of time and determining which pre-defined slope threshold is met by the calculated slope. For example, pre-defined slope thresholds may correspond to a flat pattern (e.g., a near-zero slope threshold), a steady rise pattern (e.g., a slope threshold greater than the flat pattern slope threshold), or a rapid rise pattern (e.g., a slope threshold greater than the steady rise pattern slope threshold). Slope classification may be useful to determine the behavior of a workload over a certain time period. In some implementations, slope classification may detect increasing patterns, decreasing patterns, bursty rises, etc., of packet drops or queue length.

Hot spot/cold spot detection may include calculating a segmented linear regression for a type of network performance data 103, calculating an area-under-a-curve of that same type of network performance data 103 relative to the segmented linear regression, and determining whether the area-under-the-curve is greater than or less than a pre-defined threshold associated with a hot spot or cold spot designation. For example, an area-under-the-curve greater than a hot spot threshold may confirm the existence of a hot spot in the network performance data 103 (e.g., high utilization or overutilization of a resource), while an area-under-the-curve less than a cold spot threshold may confirm the existence of a cold spot in the network performance data 103 (e.g., low utilization or underutilization of a resource). In some implementations, it may be useful to detect and confirm a hot spot or cold spot in packet or queue forwarding speed.

In some implementations, an instance of the rapid analytics module 114 is deployed per server system 140 and per fabric interconnect 130, which may be useful for scaling the system 100 linearly with changes in the size of the environment (i.e., increase or decrease in the number of server systems 104). The analytics engine 108 may be customized per workload, per server system, and/or per fabric interconnect by template-based configuration. For example, parameters such as data sample count or frequency may be adjusted by template-based configuration. The rapid analytics module 114 and the long term analytics module 116 may make the rapid trend (112) and the long term trend (122) available to the low level controller 110 or the upper level controller 120 respectively.

The low level controller 110 consumes the specification 106 and rapid trends 112 from the rapid analytics module 114 to perform dynamic network resource control for a specific workload, which may alleviate congestion related to the specific workload. Network resources may include, for example, bandwidth, latency, or the like, which may be controllable (adjustable) at the fabric interconnects 130 and/or the server systems 140 or by routing traffic to fabric interconnects 130 and/or server systems 140 with higher available bandwidth or lower latency. Because the low level controller 110 performs dynamic network resource control exclusively for a specific workload, such as a high priority workload (as opposed to multiple or all workloads 142), the low level controller 110 may be computationally lightweight.

In some implementations, the low level controller 110 reallocates at least some of a network resource (e.g., bandwidth, latency, etc.) from low priority workloads to a high priority workload, when a rapid trend 112 for the high priority workload violates a corresponding QoS parameter. For example, the low level controller 110 may detect that the rapid trend 112 for the high priority workload violates the QoS parameter for the high priority workload if the moving average of the queue length or of packet drops (i.e., rapid trend 112) exceeds a threshold specified by the QoS parameter for the high priority workload. In some implementations, a violation of the QoS parameter may be a predictive violation (i.e., a violation is predicted to occur within a pre-defined duration), based on a regression model for example.

Upon detection of a violation, the low level controller 110 may reallocate bandwidth from low priority workloads to the associated high priority workload or may move the high priority workload to a lower latency fabric interconnect. The low level controller 110 may take any action to bring network performance associated with the high priority workload into compliance with the corresponding QoS parameter, without regard for other workloads visible to the system 100. In particular, the low level controller 110 may be useful for mitigating packet drops caused by bursty loads and spikes of high priority workloads.

In some implementations, the low level controller 110 may be deployed at a fabric interconnect of the fabric interconnects 130 or at a server system of the server systems 140. In this manner, the low level controller 110 may be able to react quickly to QoS parameter violations (i.e., real time control) by detecting violations and adjusting network resources at the interconnect or server system where the low level controller 110 is deployed.

The upper level controller 120 consumes the specification 106 and long term trends 122 from the long term analytics module 116 to perform dynamic network resource sharing among different workloads, with the intent to achieve optimized resource usage while minimizing packet drops for higher priority workloads. The upper level controller 120 reallocates a network resource (such as bandwidth, latency, etc.) among the workloads 142, based on long term trends for all workloads 142, for compliance with at least a minimum level of a QoS parameter of each workload.

In some implementations, the upper level controller 120 reallocates at least some of the network resource among the workloads in the following example manner. The upper level controller 120 may periodically monitor the long term trend(s) (e.g. 122) for all workloads 142. For example, the upper level controller 120 may iterate sequentially through all of the workloads 142 in an order from highest priority to lowest priority. The upper level controller 120 detects if long term trends related to packet drops for a particular workload (e.g., the workload of the current iteration, if iterating sequentially through all workloads) exhibit both an increasing-type slope classification (e.g., either a steady or rapid rise pattern) and a hot spot. The upper level controller 120 also determines whether there is spare network resource (e.g., bandwidth, latency, etc.) available among the workloads 142.

If the upper level controller 120 verifies that there is no spare bandwidth available among the workloads 142 and detects an increasing-type slope classification and hot spot, then the upper level controller 120 may allocate to each workload having a lower priority level than the particular workload a minimum amount of network resource specified by a respective associated QoS parameter. To each workload having a higher priority level than the particular workload, the upper level controller 120 may allocate an average current amount of network resource used respectively by those workloads. To the particular workload itself, the upper level controller 120 may allocate remaining network resource made available by allocation to each workload having a lower priority level of the minimum amount of network resource. By virtue of the foregoing allocations, the upper level controller 120 sets those lower priority workloads to a minimum network resource usage to free resources to reallocate to the particular workload.

Accordingly, the system 100 may adapt to changes in workload patterns and dynamics for a specific workload via the low level controller 110 while also fairly balancing network resources among all workloads (including low priority workloads) via the upper level controller 120. In some implementations, the low level controller 110 and the upper level controller 120 may intentionally compete for network resources to result in an optimal balance of control.

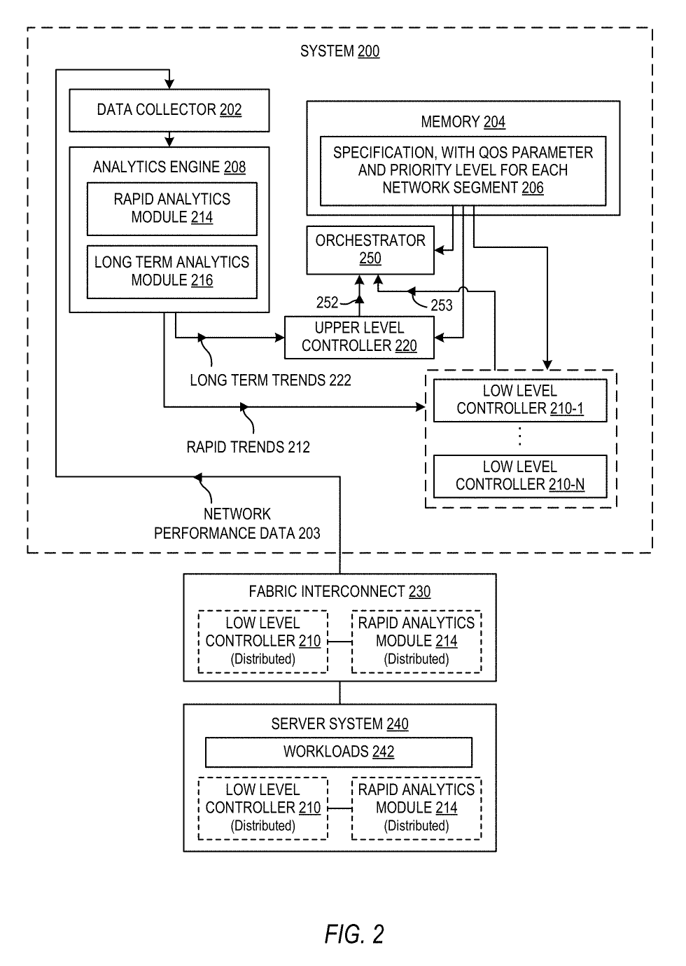

FIG. 2 is a block diagram depicting an example system 200 that manages QoS compliance of workloads according to another implementation. The system 200 includes a data collector 202, a memory 204 (e.g., RAM, non-volatile RAM, etc.), an analytics engine 208, a plurality of low level controllers 210-1 through 210-N (also referred to collectively as low level controllers 210 or individually and generally as a low level controller 210), an upper level controller 220, and an orchestrator 250.

The data collector 202, the analytics engine 208, the low level controllers 210, the upper level controller 220, and the orchestrator 250 each may be any combination of hardware (e.g., processing resource) and programming (e.g., processor executable instructions stored on a non-transitory machine-readable storage medium), electronic circuitry, or logic for implementing functionality described herein. The data collector 202, the memory 204, the analytics engine 208, each of the low level controllers 210, and the upper level controller 220 may be analogous in many respects to the data collector 102, the memory 104, the analytics engine 108, the low level controller 110, and the upper level controller 120 of FIG. 1 described above. For example, the data collector 202 receives from server systems 240 and fabric interconnects 230 network performance data 203 related to workloads 242 of server systems 240, the analytics engine 208 includes a rapid analytics module 214 and a long term analytics module 216 to calculate respectively rapid trends 212 and long term trends 222 using the network performance data 203, the low level controllers 210 manage compliance of a specific high priority workload to a corresponding QoS parameter (e.g., by reallocating network resources to the high priority workload if QoS parameter violated), and the upper level controller 220 manages compliance of all workloads 242 to respective QoS parameters.

The system 200 includes a plurality of low level controllers 210-1 through 210-N. In particular, each of the low level controllers 210 may independently manage a different workload of the workloads 242 for compliance with a corresponding QoS parameter of that different workload. Each low level controller 210 may thus be lightweight, by virtue of being focused on managing a specific workload.

The orchestrator 250 may spawn the upper level controller 220 and the low level controllers 210. In some implementations, the orchestrator 250 may be deployed in a management virtual machine (or a container, or the like) on one of the server systems 240. In some implementations, the upper level controller 220 may be deployed (e.g., spawned by the orchestrator 250) in a management virtual machine (or container, etc.) on one of the server systems 240, whether the same or different management virtual machine as the orchestrator 250.

In some implementations, parts of the system 200, such as the orchestrator 250, the analytics engine 208, the lower level controllers 210, the upper level controller 220, etc., may be distributed systems deployed to various server systems 240 and/or fabric interconnects 230. For example, a low level controller 210 may be deployed (e.g., spawned by the orchestrator 250) on fabric components such as an interconnect 230 and/or on a server system 240, as illustrated by the low level controllers 210 (distributed) in dashed lines in FIG. 2. Moreover, a rapid analytics module 214 may be deployed as attached to the distributed low level controller 210 in order to quickly feed rapid trends to the low level controller 210, as illustrated by the rapid analytics module 214 (distributed) in dashed lines. In such a case, the rapid analytics module 214 and low level controllers 210 illustrated in solid lines in FIG. 2 may be understood to be functionally part of the system 200, but may be deployed in a distributed manner as illustrated in dashed lines. By virtue of distributed deployment, the distributed low level controller 210 may be able to react quickly to QoS parameter violations (i.e., real time control) by detecting violations and adjusting network resources locally at the interconnect or server system where the low level controller 110 is deployed.

In some scenarios, the upper level controller 220 and/or one or more of the low level controllers 210 may be unable to comply with corresponding QoS parameters. There may be insufficient total resources available in the environment for all of the workloads 242, owing to a sudden surge in a workload for example. Network performance data for the workloads 242 may exhibit oscillatory behaviors as the low level controllers 210 and the upper level controller 220 compete for resources. An upper level controller 220 or low level controller 210 that is unable to meet QoS parameters may respectively signal a notification 252 or 253 of such failure to meet QoS parameters to the orchestrator 250.

The orchestrator 250 responds to notifications 252, 253 received contemporaneously from both the upper level controller 220 and a low level controller 210 by issuing a workload throttle request to server system(s) 240. For example, the throttle request may be issued to a server system 240 running a low priority workload. In another implementation, the orchestrator 250 may calculate a recommended throttle setting (e.g., bandwidth) for high priority workloads that is a minimum bandwidth plus a configurable safety margin (e.g., 10%), while providing the respective minimum bandwidths for all other workloads as a recommended throttle settings for those other workloads, where minimum bandwidth per workload 242 is specified in the QoS parameters of specification 206. In this manner, the orchestrator 250 may be able to mediate conflicts between the upper level controller 220 and low level controllers 210.

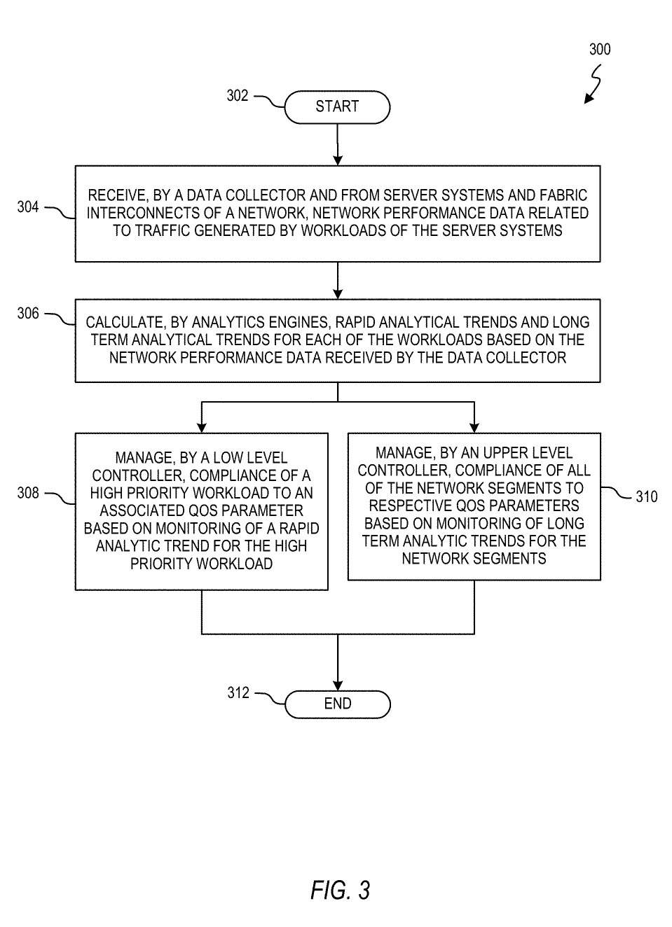

FIG. 3 is a flow diagram depicting an example method 300 for managing QoS compliance of workloads. Method 300 may be implemented in the form of executable instructions stored on a machine readable medium and executed by a processing resource (e.g., a microcontroller, a microprocessor, central processing unit core(s), an ASIC, an FPGA, etc.) and/or in the form of electronic circuitry. For example, method 300 may be performed by the system 100 or 200 described above, and the components thereof.

In some implementations, one or more blocks of method 300 may be executed substantially concurrently or in a different order than shown in FIG. 3. In some implementations, method 300 may include more or fewer blocks than are shown in FIG. 3. In some implementations, one or more of the blocks of method 300 may, at certain times, be ongoing and/or may repeat.

Method 300 may begin at block 302 and continue to block 304, where a data collector (e.g., 102) receives, from server systems (e.g., 140) and fabric interconnects (e.g., 130) of a network, network performance data (e.g., 103) related to traffic generated by workloads (e.g. 142) of the server systems. Network performance data may include queue statistics from fabric interconnects or port statistics from server systems.

At block 306, an analytics engine (e.g., 108) calculates rapid analytical trends (e.g., 112) via a rapid analytics module (e.g., 114) and long term analytical trends (e.g., 122) via a long term analytics module (e.g., 116), for each of the workloads based on the network performance data received by the data collector. In some implementations, individual analytics engines may be deployed per server system and fabric interconnect. Moreover, the rapid analytics module may be deployed on a server system and/or a fabric interconnect, as discussed with respect to rapid analytics module 114 or 214 above for example. Calculating rapid analytical trends may include, for example, calculating moving average and linear regression of network performance data received by the data collector at a sampling rate on the order of a second or faster. Calculating long term analytical trends may include, for example, performing noise reduction (e.g., via a moving average), calculating trend patterns and predictions (e.g., using linear regression of the network performance data), detecting rise/fall patterns (e.g., using slope analysis of the linear regression of the network performance data), or detecting a hot spot or cold spot (e.g., based on an area under a curve of network performance data relative to the linear regression).

The rapid analytical trends and the long term analytical trends calculated by the analytics engine at block 306 may be consumed by a low level controller (e.g., 110) and an upper level controller (e.g., 120) at blocks 308 and 310, respectively. In some implementations, blocks 308 and 310 may be performed by the low level controller and the upper level controller in parallel or concurrently.

At block 308, the low level controller manages compliance of a high priority workload of the workloads to a QoS parameter (e.g., of specification 106) associated with the high priority workload, based on monitoring of a rapid analytic trend for the high priority workload. That is, the low level controller attempts to keep the performance of the high priority workload, as represented by the rapid analytic trend, in compliance with an associated QoS parameter. As discussed above, the low level controller may be deployed to fabric components in a distributed manner to provide quick response to QoS violations of the high priority workload.

At block 310, the upper level controller manages compliance of all of the workloads to respective QoS parameters based on monitoring of long term analytic trends for the workloads. For example, the upper level controller may attempt to balance sharing of network resources among all workloads and prevent starving lower priority workloads of resources. At block 312, method 300 ends.

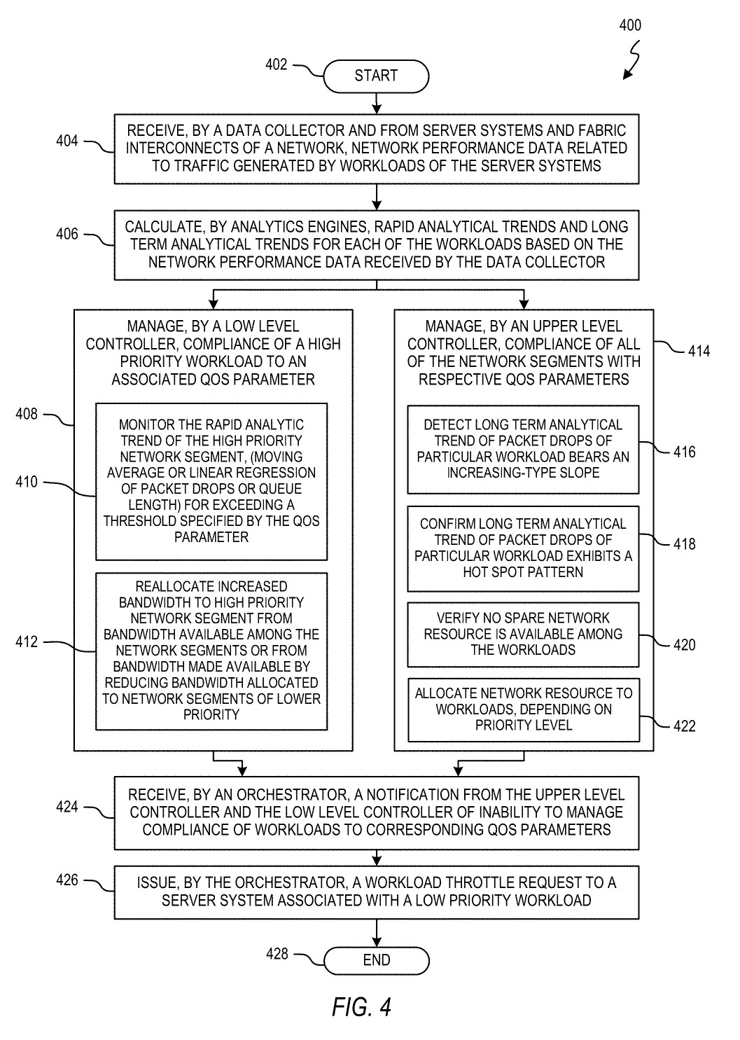

FIG. 4 is a flow diagram depicting an example method 400 for managing QoS compliance of workloads. As with method 300, method 400 may be implemented in the form of electronic circuitry and/or logic or in the form of executable instructions stored on a machine readable medium and executed by a processing resource. Method 400 may be performed by the system 100 or 200 described above, and the components thereof. In some implementations, one or more blocks of method 400 may be executed substantially concurrently or in a different order than shown in FIG. 4, method 400 may include more or fewer blocks than are shown in FIG. 4, and one or more of the blocks of method 400 may be ongoing and/or may repeat.

Method 400 may begin at block 402 and proceed to blocks 404 and 406, which may be analogous in many respects to blocks 304 and 306 described above, respectively. For example, block 406 may generate rapid analytical trends and long term analytical trends for each workload, which may then be consumed by a low level controller (e.g., 110, 210) and an upper level controller (e.g., 120, 220) at blocks 408 and 414, respectively. In some implementations, blocks 408 and 414 may be performed by the low level controller and the upper level controller in parallel or concurrently.

At block 408, the low level controller manages compliance of a specific high priority workload of the workloads to an associated QoS parameter. In some implementations, block 408 may be performed by performing sub-blocks 410 and 412. At sub-block 410, the low level controller monitors the rapid analytic trend of the high priority workload, which includes a moving average or linear regression of packet drops or queue length, for exceeding a threshold specified by the QoS parameter for the high priority workload. If the threshold is exceeded, thus indicating that packet drops or queue length have increased or are increasing to unacceptable levels per a service level objective, the low level controller may, at sub-block 412, reallocate an increased amount of network resource to the high priority workload from network resource available among the workloads or from network resource made available by reducing network resource allocated to workloads of lower priority.

At block 414, the upper level controller manages compliance of all of the workloads to respective QoS parameters based on monitoring of long term analytic trends for the workloads. In some implementations, block 414 may be performed by evaluating, in order from highest to lowest priority of the workloads, long term analytical trends of packet drop for each of the workloads. Each iterative evaluation of a workload in priority order may include performing sub-blocks 416, 418, 420, and 422 on the particular workload of the present iteration. At sub-block 416, the upper level controller may detect that a long term analytical trend of packet drops of a particular workload bears an increasing-type slope classification (e.g., steady rise pattern or rapid rise pattern). At sub-block 418, the upper level controller may confirm that a long term analytical trend of packet drops of the particular workload exhibits a hot spot pattern. At sub-block 420, the upper level controller may verify that no spare network resource is available among the workloads.

At sub-block 422, in response to detecting the increasing-type slope classification (at 416), confirming the hot spot pattern (at 418), and verifying the absence of spare network resource (at 420), the upper level controller may calculate a new allocation of network bandwidth for the workloads depending on workload priority level. The upper level controller may allocate, to each workload having a lower priority level than the particular workload, a minimum amount of network resource specified by an associated QoS parameter of each respective workload. The upper level controller may allocate an average current amount of network resource for each workload having a higher priority level than the particular workload. The upper level controller may allocate, to the particular workload, the remaining network resource made available by allocation to each workload having a lower priority level of the minimum amount of network resource.

At block 424, an orchestrator (e.g., 250) may receive notifications from the upper level controller and the low level controller of an inability to manage compliance of workloads to corresponding QoS parameters. In response to receiving the notifications, the orchestrator at block 426 may issue a workload throttle request to a server system associated with a low priority workload. In some implementations, the orchestrator may issue a throttle request to multiple server systems associated with respective workloads of any priority level. At block 428, method 400 ends.

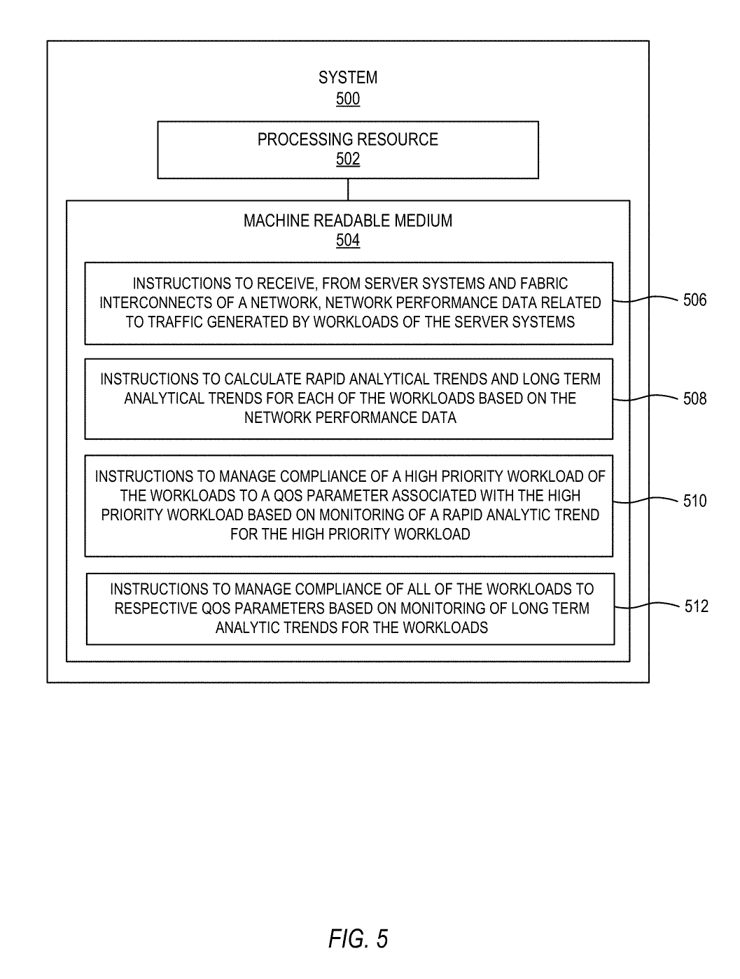

FIG. 5 is a block diagram of an example system 500 that includes a processing resource 502 coupled to a non-transitory, machine readable medium 504 encoded with example instructions to manage QoS compliance of workloads. The processing resource 502 may include a microcontroller, a microprocessor, central processing unit core(s), an ASIC, an FPGA, and/or other hardware device suitable for retrieval and/or execution of instructions from the machine readable medium 504 to perform functions related to various examples. Additionally or alternatively, the processing resource 502 may include electronic circuitry for performing the functionality of the instructions described herein.

The machine readable medium 504 may be any medium suitable for storing executable instructions, such as RAM, ROM, EEPROM, flash memory, a hard disk drive, an optical disc, or the like. The machine readable medium 504 may be disposed within the system 500, as shown in FIG. 5, in which case the executable instructions may be deemed “installed” or “embedded” on the system 500. Alternatively, the machine readable medium 504 may be a portable (e.g., external) storage medium, and may be part of an “installation package.” The instructions stored on the machine readable medium 504 may be useful for implementing at least part of the file store management engines and methods described herein.

As described further herein below, the machine readable medium 504 may be encoded with a set of executable instructions 506, 508, 510, 512. It should be understood that part or all of the executable instructions and/or electronic circuits included within one box may, in alternate implementations, be included in a different box shown in the figures or in a different box not shown.

Instructions 506, upon execution, cause the processing resource 502 to receive, from server systems and fabric interconnects of a network, network performance data related to traffic generated by workloads of the server systems. Instructions 508, upon execution, cause the processing resource 502 to calculate rapid analytical trends and long term analytical trends for each of the workloads based on the network performance data received by instructions 506.

Instructions 510, upon execution, cause the processing resource 502 to manage compliance of a high priority workload of the workloads to a QoS parameter associated with the high priority workload based on monitoring of a rapid analytic trend for the high priority workload. In some implementations, instructions 510 may include instructions to monitor the rapid analytic trend of the high priority workload, which includes a moving average or linear regression of packet drops or queue length, for exceeding a threshold specified by the QoS parameter for the high priority workload. Instructions 510 may also include instructions to respond to the rapid analytic trend exceeding the threshold by reallocating an increased amount of network resource to the high priority workload from network resource available among the workloads or from network resource made available by reducing network resource allocated to workloads of lower priority. In this manner, execution of instructions 510 may be similar in many respects to performing block 408 of method 400.

Instructions 512, upon execution, cause the processing resource 502 to manage compliance of all of the workloads to respective QoS parameters based on monitoring of long term analytic trends for the workloads. In some implementations, instructions 512 may include instructions to evaluate, in order from highest to lowest priority of the workloads, long analytical term trends of packet drop for each of the workloads. Instructions 512 may include instructions to detect an increasing-type slope classification and a hot spot pattern in a long term analytical trend regarding packet drops of a particular workload and instructions to verify that no spare network resource is available among the workloads. Instructions 512 also may include instructions to respond to detection of the increasing-type slope classification and hot spot pattern and verification of no spare network resource available among the workloads by allocating to each workload having a lower priority level than the particular workload a minimum amount of network resource specified by an associated QoS parameter of the each workload, allocating an average current amount of network resource for each workload having a higher priority level than the particular workload, and allocating to the particular workload of remaining network resource made available by allocation to each workload having a lower priority level of the minimum amount of network resource. In this manner, executing instructions 512 may be similar in many respects to performing block 414 of method 400.

In some implementations, the machine readable medium 504 may also include instructions to receive a specification that describes, for each of the workloads, QoS parameters and a priority level. Such a specification may be stored in memory of the system 500. The specification may be received via a user interface, for example.

In some implementations, the machine readable medium 504 may also include instructions to respond to notifications of failure to manage compliance of all the workloads and failure to manage compliance of the high priority workload by issuing a workload throttle request to a server system associated a low priority workload. Execution of such instructions may be similar in many respects to performing blocks 424 and 426 of method 400.

In the foregoing description, numerous details are set forth to provide an understanding of the subject matter disclosed herein. However, implementation may be practiced without some or all of these details. Other implementations may include modifications and variations from the details discussed above. It is intended that the following claims cover such modifications and variations.

What is claimed:

1. A system comprising:
a data collector that receives, from server systems and fabric interconnects, time-series network performance data related to traffic generated by workloads of the server systems;
a memory that stores a specification describing, for each of the workloads, a quality of service (QoS) parameter and a priority level;
an analytics engine per server system and per fabric interconnect, each analytic engine including a rapid analytics module and a long term analytics module to calculate respectively rapid trends and long term trends for the workloads, using as input the network performance data received by the data collector, the rapid trends based on sampling rates faster than sampling rates on which the long term trends are based;
a low level controller that reallocates at least some of a network resource from low priority workloads to a high priority workload when a rapid trend for the high priority workload violates a corresponding QoS parameter; and
an upper level controller that reallocates the network resource among the workloads, based on long term trends for all workloads, for compliance with at least a minimum level of a QoS parameter of each workload.

2. The system of claim 1, further comprising:
an orchestrator that responds to notifications from both the upper level controller and the low level controller of an inability to meet a QoS parameter by issuance of a workload throttle request to a server system associated with a low priority workload.

3. The system of claim 1, wherein the network performance data includes: queue statistics from fabric interconnects including forwarding speed, queue length, and packet drops; and port statistics from server systems including total packets forwarded and total packet drops.

4. The system of claim 1, wherein the rapid analytics module of the analytics engine calculates rapid trends using network performance data received by the data collector at a sampling rate on the order of a second or faster, and
the rapid trends include a moving average of the network performance data and a linear regression of the network performance data.

5. The system of claim 1, wherein the long term analytics module of the analytics engine calculates long term trends, using trend pattern detection and prediction, a rise/fall pattern detection, and hot spot/cold spot detection, based on network performance data received by the data collector at a sampling rate on the order of multiple seconds or slower.

6. The system of claim 1, wherein the rapid trend for the high priority workload includes a moving average of a queue length or of packet drops, and
the low level controller detects that the rapid trend for the high priority workload violates the QoS parameter for the high priority workload if the moving average of the queue length or of packet drops exceeds a threshold specified by the QoS parameter for the high priority workload.

7. The system of claim 1, wherein the low level controller is deployed at a fabric interconnect of the fabric interconnects or a server system of the server systems.

8. The system of claim 2, wherein the upper level controller and the orchestrator are deployed in a management virtual machine of a server system.

9. The system of claim 1, the upper level controller reallocates the network resource among the workloads by:
detection that a long term trend of packet drops for a particular workload exhibits an increasing-type slope classification and exhibits a hot spot;
verification of no spare network resource available among the workloads; and
in response to the detection and verification:
allocation, to each workload having a lower priority level than the particular workload, of a minimum amount of network resource specified by an associated QoS parameter of the each workload,
allocation of an average current amount of network resource for each workload having a higher priority level than the particular workload, and
allocation to the particular workload of remaining network resource made available by allocation to each workload having a lower priority level of the minimum amount of network resource.

10. The system of claim 1, further comprising a plurality of low level controllers, each to manage a different workload for compliance with a corresponding QoS parameter.

11. A method comprising:
receiving, by a data collector and from server systems and fabric interconnects of a network, network performance data related to traffic generated by workloads of the server systems;
calculating, by analytics engines, rapid analytical trends and long term analytical trends for each of the workloads based on the network performance data received by the data collector;
managing, by a low level controller, compliance of a high priority workload of the workloads to a quality of service (QoS) parameter associated with the high priority workload based on monitoring of a rapid analytic trend for the high priority workload; and
managing, by an upper level controller, compliance of all of the workloads to respective QoS parameters based on monitoring of long term analytic trends for the workloads.

12. The method of claim 11, further comprising responding, by an orchestrator, to notifications from the upper level controller and the low level controller of inability to manage compliance of workloads to corresponding QoS parameters by issuing a workload throttle request to a server system associated with a low priority workload.

13. The method of claim 11, wherein:
the calculating rapid analytical trends includes calculating moving average and linear regression of network performance data received by the data collector at a sampling rate on the order of a second or faster,
the calculating long term analytical trends includes performing noise reduction, calculating trend patterns and predictions, detecting rise/fall patterns, and detecting a hot spot or cold spot, using network performance data received by the data collector at a sampling rate on the order of multiple seconds or slower, and
network performance data includes queue statistics from fabric interconnects or port statistics from server systems.

14. The method of claim 11, wherein the managing by the low level controller includes:
monitoring the rapid analytic trend of the high priority workload, which includes a moving average or linear regression of packet drops or queue length, for exceeding a threshold specified by the QoS parameter for the high priority workload, and
reallocating increased amount of network resource to the high priority workload from network resource available among the workloads or from network resource made available by reducing network resource allocated to workloads of lower priority.

15. The method of claim 11, wherein the managing by the upper level controller includes:
evaluating, in order from highest to lowest priority of the workloads, long term analytical trends of packet drop for each of the workloads,
detecting, during the evaluating, that a long term analytical trend of packet drops of a particular workload bears an increasing-type slope classification,
confirming that a long term analytical trend of packet drops of the particular workload exhibits a hot spot pattern,
verifying that no spare network resource is available among the workloads, and
in response to the detecting, the confirming, and the verifying:
allocating, to each workload having a lower priority level than the particular workload, of a minimum amount of network resource specified by an associated QoS parameter of the each workload,
allocating of an average current amount of network resource for each workload having a higher priority level than the particular workload, and
allocating to the particular workload of remaining network resource made available by allocation to each workload having a lower priority level of the minimum amount of network resource.

16. A non-transitory machine readable medium storing instructions executable by a processing resource of a system, the non-transitory machine readable medium comprising:
instructions to receive, from server systems and fabric interconnects of a network, network performance data related to traffic generated by workloads of the server systems;
instructions to calculate rapid analytical trends and long term analytical trends for each of the workloads based on the network performance data;
instructions to manage compliance of a high priority workload of the workloads to a quality of service (QoS) parameter associated with the high priority workload based on monitoring of a rapid analytic trend for the high priority workload; and
instructions to manage compliance of all of the workloads to respective QoS parameters based on monitoring of long term analytic trends for the workloads.

17. The non-transitory machine readable medium of claim 16, further comprising:
instructions to receive a specification that describes, for each of the workloads, QoS parameters and a priority level;

18. The non-transitory machine readable medium of claim 16, further comprising:
instructions to respond to notifications of failure to manage compliance of all the workloads and failure to manage compliance of the high priority workload by issuance of a workload throttle request to a server system associated a low priority workload.

19. The non-transitory machine readable medium of claim 16, wherein the instructions to manage compliance of the high priority workload include:
instructions to monitor the rapid analytic trend of the high priority workload, which includes a moving average or linear regression of packet drops or queue length, for exceeding a threshold specified by the QoS parameter for the high priority workload, and
instructions to respond to the exceeding the threshold by reallocation of increased amount of network resource to the high priority workload from network resource available among the workloads or from network resource made available by reducing network resource allocated to workloads of lower priority.

20. The non-transitory machine readable medium of claim 16, wherein the instructions to manage compliance of all of the workloads include:
instructions to evaluate, in order from highest to lowest priority of the workloads, long analytical term trends of packet drop for each of the workloads,
instructions to detect an increasing-type slope classification and a hot spot pattern in a long term analytical trend regarding packet drops of a particular workload,
instructions to verify that no spare network resource is available among the workloads, and
instructions to, in response to the detection of the increasing-type slope classification and hot spot pattern and a verification of no spare network resource available among the workloads:
allocate, to each workload having a lower priority level than the particular workload, of a minimum amount of network resource specified by an associated QoS parameter of the each workload,
allocate an average current amount of network resource for each workload having a higher priority level than the particular workload, and
allocate to the particular workload of remaining network resource made available by allocation to each workload having a lower priority level of the minimum amount of network resource.
